(19) United States
(12) Patent Application Publication
(10) Pub. No.: US 2026/0163914 A1
(43) Pub. Date: Jun. 11, 2026

(54) METHOD AND APPARATUS FOR PROTECTING AGAINST ABNORMAL NETWORK BEHAVIOR, COMPUTER DEVICE, AND STORAGE MEDIUM

(71) Applicant: TENCENT TECHNOLOGY (SHENZHEN) COMPANY LIMITED, Shenzhen (CN)

(72) Inventors: Chaoli WANG, Shenzhen (CN); Wentao WEI, Shenzhen (CN); Guojin SUN, Shenzhen (CN); Ruichang HUANG, Shenzhen (CN); Haibing LIANG, Shenzhen (CN); Xing XIE, Shenzhen (CN); Hao WU, Shenzhen (CN)

(21) Appl. No.: 19/179,868

(22) Filed: Apr. 15, 2025

Related U.S. Application Data
(63) Continuation of application No. PCT/CN2024/073669, filed on Jan. 23, 2024.

(30) Foreign Application Priority Data
Mar. 23, 2023 (CN) 202310320577.X

(51) Int. Cl. H04L 9/40

(52) U.S. Cl. CPC H04L 63/1441; H04L 63/1425

(57) ABSTRACT

A method for protecting against an abnormal network behavior includes: receiving a data request corresponding to a target network segment forwarded by a network operator; obtaining protection information corresponding to a network address, the protection information being generated by a client server based on a service requirement; performing data scrubbing on the data request based on the protection information to obtain a scrubbed data request; and transmitting the scrubbed data request to the cloud server to instruct the cloud server to perform data filtering on the scrubbed data request according to the protection information to obtain a target data request after a data request of an abnormal behavior type is filtered out, and transmitting the target data request to the client server.

### CROSS-REFERENCES TO RELATED APPLICATIONS

This application is a continuation of PCT Application No. PCT/CN2024/073669, filed on Jan. 23, 2024, which claims priority to Chinese Patent Application No. 202310320577.X, entitled “METHOD AND APPARATUS FOR PROTECTING AGAINST ABNORMAL NETWORK BEHAVIOR, COMPUTER DEVICE, AND STORAGE MEDIUM”, filed with the China National Intellectual Property Administration on Mar. 23, 2023, the entire contents of both of which are incorporated herein by reference.

### FIELD OF THE TECHNOLOGY

The present disclosure relates to the field of computer technologies, and in particular, to a method and apparatus for protecting against an abnormal network behavior, a computer device, a storage medium, and a computer program product.

### BACKGROUND OF THE DISCLOSURE

A distributed denial of service (DDoS) attack means that a plurality of computers transmit a large number of requests to cause a target server to use up computing resources or a network to use up bandwidth resources, so that the target server is out of service, and it even dangers the data security of the target server.

A DDoS request transmitted by a corresponding area is usually protected against through a network operator, and attack protection provided by the network operator has limitations. As a result, the protection of the network operator on the DDoS request may fail, causing a potential security risk to the target server.

### SUMMARY

According to various embodiments of the present disclosure, a method and apparatus for protecting against an abnormal network behavior, a computer device, a computer-readable storage medium, and a computer program product.

In one aspect, the present disclosure provides a method for protecting against an abnormal network behavior, performed by a scrubbing center, and including: receiving a data request corresponding to a target network segment forwarded by a network operator, the target network segment being a network segment corresponding to a network address of a client server; obtaining protection information corresponding to the network address, the protection information being generated by the client server based on a service requirement; performing data scrubbing on the data request based on the protection information to obtain a scrubbed data request; and transmitting the scrubbed data request to a cloud server to instruct the cloud server to perform data filtering on the scrubbed data request according to the protection information to obtain a target data request after a data request of an abnormal behavior type is filtered out, and transmitting the target data request to the client server.

In another aspect, the present disclosure further provides an apparatus for protecting against an abnormal network behavior. The apparatus includes: a data request receiving module, configured to receiving a data request corresponding to a target network segment forwarded by a network operator, the target network segment being a network segment corresponding to a network address of a client server; a first protection information obtaining module, configured to obtain protection information corresponding to the network address, the protection information being generated by the client server based on a service requirement; a first scrubbing module, configured to perform data scrubbing on the data request based on the protection information to obtain a scrubbed data request; and a scrubbed data request transmission module, configured to transmit the scrubbed data request to a cloud server to instruct the cloud server to perform data filtering on the scrubbed data request according to the protection information to obtain a target data request after a data request of an abnormal behavior type is filtered out, and transmitting the target data request to the client server.

In another aspect, the present disclosure further provides a computer device, including a memory and one or more processors, the memory having computer-readable instructions stored therein, and the computer-readable instructions, when executed by the processors, cause the one or more processors to perform the following operations: receiving a data request corresponding to a target network segment forwarded by a network operator, the target network segment being a network segment corresponding to a network address of a client server; obtaining protection information corresponding to the network address, the protection information being generated by the client server based on a service requirement; performing data scrubbing on the data request based on the protection information to obtain a scrubbed data request; and transmitting the scrubbed data request to a cloud server to instruct the cloud server to perform data filtering on the scrubbed data request according to the protection information to obtain a target data request after a data request of an abnormal behavior type is filtered out, and transmitting the target data request to the client server.

In another aspect, the present disclosure further provides one or more non-transitory readable storage media, having computer-readable instructions stored therein, and the computer-readable instructions, when executed by a processor, implement the following operations: receiving a data request corresponding to a target network segment forwarded by a network operator, the target network segment being a network segment corresponding to a network address of a client server; obtaining protection information corresponding to the network address, the protection information being generated by the client server based on a service requirement; performing data scrubbing on the data request based on the protection information to obtain a scrubbed data request; and transmitting the scrubbed data request to a cloud server to instruct the cloud server to perform data filtering on the scrubbed data request according to the protection information to obtain a target data request after a data request of an abnormal behavior type is filtered out, and transmitting the target data request to the client server.

In another aspect, the present disclosure provides a method for protecting against an abnormal network behavior, performed by a cloud server, and including: receiving protection information that is determined by a client server based on a service requirement and corresponds to a network address, the network address being an address of a network of the client server; transmitting the protection information and the network address to a scrubbing center, to instruct the scrubbing center to receive a data request that is forwarded by a network operator and corresponds to a target network segment, and to perform data scrubbing on the data request based on the protection information, to obtain a scrubbed data request, the target network segment being a network segment corresponding to the network address; receiving the scrubbed data request transmitted by the scrubbing center, and performing data filtering on the scrubbed data request according to the protection information, to obtain a target data request after a data request of an abnormal behavior type is filtered out; and transmitting the target data request to the client server.

Details of one or more embodiments of the present disclosure are provided in the accompanying drawings and descriptions below. Other features, objectives, and advantages of the present application will become apparent from the specification, accompanying drawings, and claims.

### BRIEF DESCRIPTION OF THE DRAWINGS

FIG. 1 is a diagram of an application environment of a method for protecting against an abnormal network behavior according to an embodiment.

FIG. 2 is a flowchart of a method for protecting against an abnormal network behavior according to an embodiment.

FIG. 3 is a schematic diagram of a method for protecting against an abnormal network behavior according to a scenario embodiment.

FIG. 4 is a flowchart of a method for protecting against an abnormal network behavior according to another embodiment.

FIG. 5 is a flowchart of a method for protecting against an abnormal network behavior according to still another embodiment.

FIG. 6 is a schematic diagram of a protection configuration page according to an embodiment.

FIG. 7 is a schematic diagram of a protection service purchase page according to an embodiment.

FIG. 8 is a schematic diagram of an elastic IP (EIP) applying page of a protection platform according to an embodiment.

FIG. 9 is a schematic diagram of a protection service management page according to an embodiment.

FIG. 10 is a schematic diagram of a protection configuration page according to an embodiment.

FIG. 11 is a schematic diagram of a protection overview page according to an embodiment.

FIG. 12 is a schematic diagram of a method for protecting against an abnormal network behavior according to another scenario embodiment.

FIG. 13 is a schematic diagram of a method for protecting against an abnormal network behavior according to still another scenario embodiment.

FIG. 14 is a flowchart of a method for protecting against an abnormal network behavior according to still another embodiment.

FIG. 15 is a block diagram of a structure of an apparatus for protecting against an abnormal network behavior according to an embodiment.

FIG. 16 is a block diagram of a structure of an apparatus for protecting against an abnormal network behavior according to another embodiment.

FIG. 17 is a diagram of an internal structure of a computer device according to an embodiment.

### DESCRIPTION OF EMBODIMENTS

To make the objectives, technical solutions, and advantages of the present disclosure clearer, the following further describes the present disclosure in detail with reference to the accompanying drawings and the embodiments. It should be understood that the specific embodiments described here are only intended to explain the present disclosure and are not intended to limit the present disclosure.

In this specification and the accompanying drawings, steps and elements that are essentially the same or similar are represented by identical or similar reference numerals, and repeated descriptions of these steps and elements will be omitted. In addition, in the descriptions of the present disclosure, the terms “first”, “second”, and the like are only for the purpose of distinguishing the description, and may not be understood as indicating or implying the relative importance or a sequence.

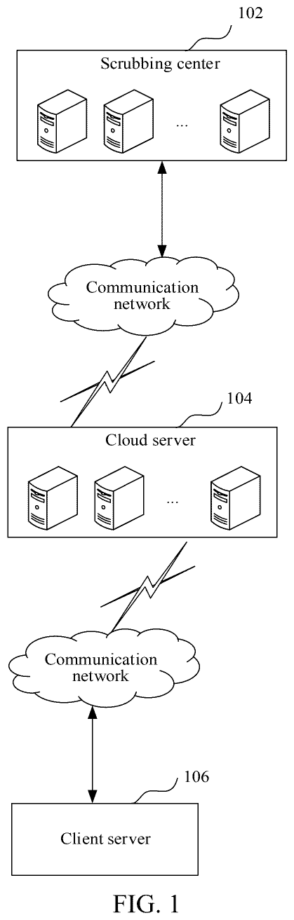

A method for protecting against an abnormal network behavior according to an embodiment of the present disclosure can be applied to an application environment shown in FIG. 1. A scrubbing center 102 communicates with a cloud server 104 through a network, and the cloud server 104 communicates with a client server 106 through a network. A data storage system can store data that needs to be processed by the cloud server 104. The data storage system may be integrated on the cloud server 104, or may be integrated on another server.

The scrubbing center 102 receives a data request that is forwarded by a network operator and corresponds to a target network segment, obtains protection information that corresponds to a network address of the client server 106 and is generated by the client server 106 based on a service requirement, and performs data scrubbing on the data request based on the protection information, to obtain a scrubbed data request. The scrubbing center 102 may transmit the scrubbed data request to the cloud server 104. The cloud server 104 performs data filtering on the scrubbed data request according to the protection information, to obtain a target data request after a data request of an abnormal behavior type is filtered out. The cloud server 104 may transmit the target data request to the client server 106.

The scrubbing center 102 may be implemented by using a cluster composed of a plurality of scrubbing nodes. The cloud server 104 may be implemented by using an independent cloud server or a plurality of cloud server clusters. The client server 106 may be an independent physical server, or may be a server cluster or a distributed system formed by a plurality of physical servers, or may be a server that provides basic cloud computing services such as cloud services, cloud databases, cloud computing, cloud functions, cloud storage, network services, cloud communication, middleware services, domain name services, security services, content delivery networks (CDNs), big data, and artificial intelligence platforms.

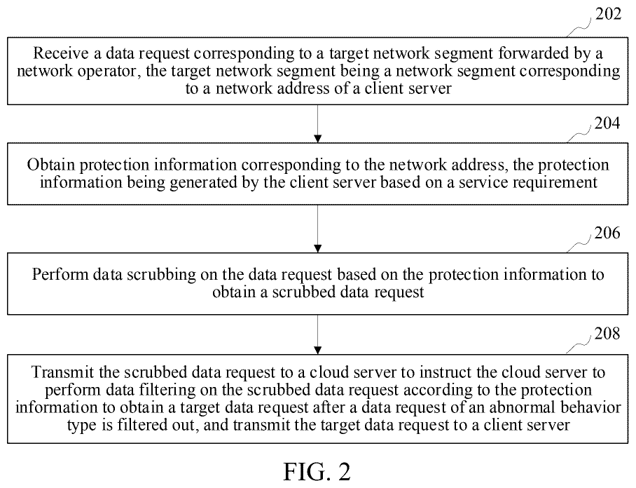

In some embodiments, as shown in FIG. 2, a method for protecting against an abnormal network behavior is provided. The method being performed by the scrubbing center in FIG. 1 is taken as an example for explanation, including the following operations:

Operation 202: Receive a data request corresponding to a target network segment forwarded by a network operator, the target network segment being a network segment corresponding to a network address of a client server.

The network operator is an entity that performs network operation and provides services. A plurality of Internet protocol (IP) addresses belong to the target network segment. During actual application, for two IP addresses, it can be determined, based on the two IP addresses and their respective subnet masks, whether the two IP addresses belong to a same network segment. The network address of the client server is an IP address belonging to the target network segment.

In some embodiments, in response to that an access device accesses the client server based on the network address, the access device transmits the data request to the network operator. The data request carries the network address of the client server. The network operator forwards, based on the target network segment to which the network address belongs, the data request to the scrubbing center corresponding to the target network segment, and the scrubbing center receives the data request forwarded by the network operator.

In some embodiments, the scrubbing center and the network operator are located in a same geographic area. For example, the scrubbing center is a scrubbing center deployed in area A. The network operator provides a network operation service for area A. An access device located in area A transmits a data request to the network operator in area A, and the network operator in area A forwards the data request to the scrubbing center deployed in area A.

In some embodiments, the scrubbing center that receives the data request forwarded by the network operator is a scrubbing center, closest to the network operator, among scrubbing centers of areas. Namely, the scrubbing centers of the areas may perform near-source scrubbing. For example, scrubbing centers are deployed in area A, area B, and area C. A network operator of area A forwards requested data to the scrubbing center of area A. Area D is closest to area C, so that a network operator of area D may forward the data request to the scrubbing center of area C.

In some embodiments, the method for protecting against the abnormal network behavior further includes: receiving the network address of the client server transmitted by the cloud server; obtaining the target network segment corresponding to the network address; and broadcasting the target network segment to the network operator, the network operator and the cloud server being located in a same geographic area.

In some embodiments, the client server binds its network address to the cloud server. The cloud server transmits the network address of the client server to the scrubbing center. The scrubbing center determines the target network segment based on the network address and the subnet mask of the network address. A router of the scrubbing center broadcasts the target network segment, so that the network operator forwards the data request with the IP address belonging to the target network segment to the scrubbing center. Since the network address of the client server belongs to the target network segment, the scrubbing center may receive the data request for accessing the client server.

In an implementation, routers of scrubbing centers of a plurality of areas broadcast target network segments in a unicast manner, and the scrubbing centers of the plurality of areas receive data requests forwarded by network operators of the areas. In another implementation, routers of scrubbing centers of a plurality of areas broadcast target network segments in an anycast manner, and in response to that a scrubbing center of an area fails, a network operator of the area may be addressed to the nearest scrubbing center.

In addition, the router of the scrubbing center may alternatively broadcast the target network segment in a multicast manner. The broadcasting manner for the target network segment may be set based on a service requirement of the client server. This is not limited in this embodiment of the present disclosure.

In the foregoing embodiment, the scrubbing center broadcasts, to the network operator, the target network segment to which the network address of the client server belongs, and then the network operator forwards, to the scrubbing center, the data request with a destination address belonging to the target network, so that the scrubbing center can obtain the data request for accessing the client server, to subsequently scrub the data request.

Operation 204: Obtain protection information corresponding to the network address, the protection information being generated by the client server based on a service requirement.

The protection information is used for reflecting a mode of protecting against a data request of an abnormal behavior type. The data request for accessing the network address of the client server may be filtered through the protection information.

The protection information may include but not limited to: a protection list, a blocked transmission protocol, and port information. The protection information may further include at least one of a protection list, a blocked transmission protocol, and port information. A data request with a source address belonging to the protection list may be filtered out through the protection list. A data request with a transmission protocol being the blocked transmission protocol may be filtered out through the blocked transmission protocol. A data request with a source port belonging to the port information may be filtered out through the port information.

In some embodiments, the client server generates the protection information corresponding to the network address according to the service requirement. For example, the data request of the abnormal behavior type, which is received by the network address of the client server, includes a large number of data requests that belong to a user datagram protocol (UDP) transmission protocol. The UDP transmission protocol is a message-oriented transport layer protocol. Further, it may be configured that the protection information includes the blocked transmission protocol. The blocked transmission protocol includes the UDP transmission protocol. The data request of the UDP transmission protocol is filtered through the protection information. In actual application, the client may perform a configuration operation through a protection configuration page based on the service requirement of the client server, to transmit configuration information to the client server, and the client server generates the protection information corresponding to the network address based on the configuration information.

The scrubbing center obtains the protection information corresponding to the network address, so that the scrubbing center can scrub the data request based on the protection information configured by the client server.

In some embodiments, operation 204 includes: receiving the protection information that is transmitted by the cloud server and corresponds to the network address.

In an implementation, the client server transmits the protection information to the cloud server. The cloud server transmits the protection information to the scrubbing center. The scrubbing center receives the protection information transmitted by the cloud server. In another implementation, when transmitting the protection information to the scrubbing center, the cloud server transmits the network address of the client server to the scrubbing center, and the scrubbing center receives the network address and the protection information corresponding to the network address.

In the foregoing embodiment, the scrubbing center receives the protection information transmitted by the cloud server, so that the scrubbing center and the cloud server have the same protection information. In addition, the protection information is configured by the client server according to the service requirement, so that the scrubbing center and the cloud server can perform targeted protection on the data request according to the protection information configured by the client server.

Operation 206: Perform data scrubbing on the data request based on the protection information to obtain a scrubbed data request.

In some embodiments, the scrubbing center determines, from the data request, a candidate data request corresponding to the network address of the client server, determines a data request of an abnormal behavior type based on the protection information corresponding to the network address, and filters out the data request of an abnormal behavior type to obtain the scrubbed data request. This enhances the scrubbing effect on the data request.

Since the scrubbing center receives the data request corresponding to the target network segment, the data request may include a data request with a destination address that is not the network address of the client server, so that the scrubbing center needs to screen out the data request corresponding to the network address of the client server and then scrub the data request corresponding to the network address. Operation S206 includes: obtaining quintuple information based on the data request; determining, from the data request corresponding to the target network segment based on the quintuple information, a candidate data request corresponding to the network address; and scrubbing the candidate data request based on the protection information, to obtain the scrubbed data request.

The quintuple information includes a source address, a source port, a destination address, a destination port, and a transport layer protocol.

In some embodiments, for the data request corresponding to the target network segment, the scrubbing center obtains the quintuple information of the data request, determines, based on the destination address included in the quintuple information, the candidate data request with the destination address that is the network address, and scrubs the candidate data request through the protection information to obtain the scrubbed data request.

In some embodiments, the scrubbing center includes a plurality of routers and a plurality of gateway nodes, and receives, through the plurality of routers, the data request that is forwarded by the operator and corresponds to the target network segment. The routers forward, based on the quintuple information of the data request, the data request to the gateway nodes in a load balancing manner, so that data having the same destination address is aggregated to the same gateway node. Thus, the candidate data request corresponding to the network address of the client server is aggregated to one gateway node. The gateway node is configured with the protection information corresponding to the network address. The candidate data request corresponding to the network address is scrubbed through the protection information corresponding to the network address.

In some embodiments, the routers forward, based on the quintuple information of the data request, the data request to the gateway nodes in a load balancing manner, which includes: The routers determine a hash result based on the quintuple information of the data request. For a previous data request that has been forwarded and a to-be-forwarded data request, when the hash results of a current data request and the to-be-forwarded data request are the same, the routers select a forwarding path of the previous data request and forward the to-be-forwarded data request to the corresponding gateway nodes. When the hash results of the current data request and the to-be-forwarded data request are different, the routers select an idle path and forward the to-be-forwarded data request to the corresponding gateway node. In actual application, a hash of an IP of the source address in the quintuple information may be used as the hash result of the quintuple information.

In some embodiments, the protection information is integrated into the gateway nodes in a form of .so library, a gateway node corresponding to the network address of the client server invokes the .so library to scrub the candidate data request. The .so library is a dynamic link library.

For example, UDP-flood is a DDoS attack. The UDP-flood means transmitting a UDP request like flood to a target device within short time, and as a result, the target device cannot make a response to normal request. To protect against the UDP-flood, the client server configures protection information used for blocking a UDP transmission protocol, and the scrubbing center integrates the protection information into the gateway node in the form of .so library. When the gateway node determines, through the .so library, that the candidate data request includes a large number of UDP requests, a message UDP request is filtered out, so that the UDP-flood is effectively relieved at the scrubbing center.

In the foregoing embodiment, the scrubbing center determines the candidate data request corresponding to the network address of the client server based on the quintuple information of the data request, and scrubs the candidate data request through the protection information to obtain the scrubbed data request, so as to perform targeted scrubbing on the candidate data request corresponding to the network address of the client server through the protection information configured by the client server, thereby improving the scrubbing effect on the data request.

Operation 208: Transmit the scrubbed data request to the cloud server to instruct a cloud server to perform data filtering on the scrubbed data request according to the protection information to obtain a target data request after a data request of an abnormal behavior type is filtered out, and transmit the target data request to the client server.

The data request of the abnormal behavior type is a data request determined according to the protection information. When the protection information includes the protection list, the data request of the abnormal behavior type may be a data request with the source address belonging to the protection list. When the protection information includes the blocked transmission protocol, the data request of the abnormal behavior type may be a data request with the transmission protocol is the blocked transmission protocol.

In some embodiments, the gateway nodes of the scrubbing center may transmit the scrubbed data request to the cloud server through a private physical line or a generic routing encapsulation (GRE) tunnel. The physical private line is a dedicated communication line for data transmission between the scrubbing center and the cloud server, and GRE is a general Routing encapsulation protocol.

The cloud server performs data filtering on the scrubbed data request through the protection information corresponding to the network address of the client server, to obtain the target data request, and the cloud server transmits the target data request to the client server through a cloud intra-network.

In addition, the candidate data request corresponding to the network address is subjected to preliminary scrubbing at the scrubbing center and is subjected to secondary scrubbing at the cloud server. The protection information used by the scrubbing center and the cloud server is configured by the client server based on the service requirement. The process in which the cloud server performs the data filtering on the scrubbed data request through the protection information is the same as the process in which the scrubbing center performs the data filtering on the candidate data request through the protection information.

In the foregoing embodiment, the scrubbing center receives the data request that is forwarded by the network operator and corresponds to the target network segment, and obtains the protection information corresponding to the network address of the client server, the protection information being generated by the client server based on the service requirement. The scrubbing center scrubs the data request through the protection information, and transmits the scrubbed data request to the cloud server. The cloud server performs data filtering on the scrubbed data request through the protection information, to obtain the target data request from which the data request of the abnormal behavior type is filtered out, and transmits the target data request to the client server. Both the scrubbing center and the cloud server perform the data scrubbing through the protection information, so that protection for the data request of the abnormal behavior type adapts to an actual service requirement of the client server. Thus, the data request of the abnormal behavior type can be effectively scrubbed at the scrubbing center, and then the cloud server performs the secondary scrubbing on the scrubbed data request to filter out a small number of data requests of the abnormal behavior type that pass through the scrubbing center, to obtain the target data request from which the data request of the abnormal behavior type is filtered out. This ensures the service stability of the client server and improves the effect of protecting against the abnormal network behavior.

In some embodiments, the protection information includes a protection list. The scrubbing the candidate data request based on the protection information, to obtain the scrubbed data request includes: obtaining a source address corresponding to the candidate data request; obtaining, from the candidate data request, a first data request with the source address belonging to the protection list; and scrubbing the first data request to obtain the scrubbed data request.

The protection list includes a protection source address, and the protection source address is a source address that is not allowed to access the client server.

In some embodiments, the gateway nodes of the scrubbing center obtain the source address of the candidate data request based on the quintuple information of the candidate data request, uses the candidate data request as the first data request in response to that the source address of the candidate data request is the protection source address included in the protection list, and scrubs the first data request in the candidate data request to obtain the scrubbed data request. In addition, the first data request is the data request of the abnormal behavior type.

In the foregoing embodiment, the protection list is set by the client server based on the service requirement, and the scrubbing center scrubs the scrubbed data request based on the protection list, so that the data request with the source address being the protection source address cannot be transmitted to the client server, thereby enhancing the effect of protecting against the abnormal network behavior.

In some embodiments, the protection information includes a blocked transmission protocol. The scrubbing the candidate data request based on the protection information, to obtain the scrubbed data request includes: obtaining, from the candidate data request in response to that a traffic of the candidate data request is greater than a traffic threshold, a second data request with a transmission protocol belonging to the blocked transmission protocol; scrubbing the second data request to obtain the scrubbed data request.

The blocked transmission protocol may include: at least one of a UDP transmission protocol, a transmission control protocol (TCP), or an Internet control message protocol (ICMP). The TCP is a connection-oriented, reliable, byte stream-based transport layer communication protocol. The ICMP is a zero-connection-oriented protocol.

When the blocked transmission protocol includes the UDP transmission protocol, a DDoS attack of a UDP-flood type may be protected against. When the blocked transmission protocol includes the TCP, the DDoS attack of a TCP-flood type may be protected against. When the blocked transmission protocol includes the ICMP transmission protocol, a DDoS attack of an ICMP-flood type may be protected against. TCP-flood means transmitting TCP requests like flood to a target device within short time, and as a result, the target device cannot make a response to a normal request. ICMP-flood means transmitting ICMP requests like flood to a target device within short time, and as a result, the target device cannot make a response to a normal request.

The traffic threshold may be set by the client server based on the service requirement, or may be determined by the scrubbing center by performing deep learning on a historical record of a neural network that protects against the abnormal network behavior.

In some embodiments, the scrubbing center obtains the traffic of the candidate data request, determines a transmission protocol of the candidate data request based on the quintuple information of the candidate data request in response to that the traffic of the candidate data request is greater than the traffic threshold, uses the candidate data request with the transmission protocol being the blocked transmission protocol as the second data request, and scrubs the second data request in the candidate data request, to obtain the scrubbed data request. In addition, the second data request is the data request of the abnormal behavior type.

For example, to protect against the TCP-flood and the ICMP-flood, the client server configures protection information in which the blocked transmission protocol includes the TCP transmission protocol and the ICMP transmission protocol. The scrubbing center determines the traffic of the candidate data request. When the traffic of the candidate data request is greater than the traffic threshold, the scrubbing center determines the second data request with the TCP transmission protocol and the ICMP transmission protocol from the candidate data request and scrubs the second data request of the candidate data request, to obtain the scrubbed data request.

In some embodiments, the protection information includes a protection list and a blocked transmission protocol, and the scrubbing the candidate data request based on the protection information, to obtain the scrubbed data request includes: obtaining a source address corresponding to the candidate data request; obtaining, from the candidate data request, a first data request with the source address belonging to the protection list; obtaining, from the candidate data request in response to that the traffic of the candidate data request is greater than the traffic threshold, a second data request with the transmission protocol belonging to the blocked transmission protocol; and scrubbing the first data request and the second data request, to obtain the scrubbed data request.

Namely, the scrubbing center determines the first data request from the candidate data request based on the protection list, determines the second data request from the candidate data request based on the blocked transmission protocol, and filters out the first data and the second data request, to scrub the data request with reference to the various types of protection information.

In some embodiments, the protection list further includes a non-protection list and a blocked transmission protocol, and the non-protection list includes a non-protection source address. The scrubbing the candidate data request based on the protection information, to obtain the scrubbed data request includes: obtaining, from the candidate data request in response to that the traffic of the candidate data request is greater than the traffic threshold, a second data request with the transmission protocol belonging to the blocked transmission protocol, and determining, from the second data request, a third data request with the source address not belonging to the non-protection list. The scrubbing center scrubs the third data request to obtain the scrubbed data request.

In some embodiments, to avoid a data request with the source address being the non-protection source address from being filtered out, in the second data request, only the third data request with the source address being not the non-protection source address is scrubbed. The non-protection source address in the non-protection list is set by the client server based on the service requirement, so that the data request with the source address being the non-protection source address can access the client server.

In the foregoing embodiment, the blocked transmission protocol is set by the client server based on the service requirement. According to the blocked transmission protocol, the scrubbing center can scrub a large number of data requests with the transmission protocol being at least one of the UDP transmission protocol, the TCP transmission protocol, or the ICMP transmission protocol, so as to protect against at least one DDoS attack that is of the UDP-flood type, the TCP-flood type, or the ICMP-flood type, thereby improving the effect of protecting against the abnormal network behavior.

In some embodiments, the method for protecting against the abnormal network behavior includes: receiving a dial test request transmitted by the cloud server; receiving, in response to that a response to the dial test request times out, a masking instruction transmitted by the cloud server; and stopping broadcasting the target network segment to the network operator based on the masking instruction.

Dial test is a means of testing network link quality. The dial test request is used for testing a link of the scrubbing center. The dial test request may be a packet Internet Groper (Ping) request. The Ping request is a network exploration request.

That the response to the dial test request times out means that a duration of making a response to the dial test request is greater than a duration threshold. For example, after the cloud server transmits the dial test request, if the cloud server does not receive a response corresponding to the dial test request within the duration threshold, the cloud server determines that the response to the dial test request times out.

In some embodiments, the cloud server may periodically transmit a Ping request to the scrubbing center. The scrubbing center receives and makes a response to the Ping request. If the response made by the scrubbing center to the Ping request times out, it indicates that a link of the scrubbing center is abnormal, the cloud server transmits a masking instruction to the scrubbing center. The scrubbing center receives the masking instruction, and stops broadcasting the target network segment to the network operator based on the masking instruction.

In some embodiments, the scrubbing center may receive a dial test request transmitted by a dial test node and makes a response to the dial test request. In response to that the dial test node determines that the response made by the scrubbing center to the dial test node times out, the dial test node determines that a link in the scrubbing center is abnormal. The dial test node feeds back, to the cloud server, a dial test result indicating that the link in the scrubbing center is abnormal. The cloud server transmits a masking instruction to the scrubbing center. The scrubbing center stops broadcasting the target network segment to the network operator based on the masking instruction.

In some embodiments, after stopping broadcasting the target network segment to the network operator, the scrubbing center may perform a link maintenance operation. In response to that the link of the scrubbing center is restored, the scrubbing center continues to broadcast the target network segment to the network operator.

In some embodiments, after the scrubbing center stops broadcasting the target network segment to the network operator, the network operator may address the nearest scrubbing center and forward the data request to the nearest scrubbing center. For example, network operator A in area A forwards the data request to scrubbing center A in area A. When a link of scrubbing center A is abnormal, scrubbing center A stops broadcasting the target network segment to network operator A, and network operator A may forward the data request to a scrubbing center in area B. The scrubbing center of area B is the scrubbing center nearest to scrubbing center A.

In some embodiments, after transmitting the masking instruction to the scrubbing center, the cloud server transmits a router broadcasting instruction to another scrubbing center, to instruct the another scrubbing center to broadcast the target network segment, so that the network operator forwards the data request corresponding to the target network segment to the another scrubbing center.

In the related art, a data request is scrubbed through a scrubbing node inside a network operator, and the cloud server cannot determine in time that a link of the scrubbing node of the network operator is abnormal. As a result, the data request cannot be normally scheduled, and the service stability of the client server is affected. In the foregoing embodiment, the cloud server may perform a dial test on the scrubbing center, and determine a link state of the scrubbing center in time. When the link of the scrubbing center is abnormal, the cloud server controls, through the masking instruction, the scrubbing center to stop broadcasting the target network segment to the network operator, so that the network operator does not forward the data request to a scrubbing center with a faulty link and the network operator may forward the data request to another scrubbing center, thereby achieving scheduling of the data request, ensuring the service stability of the client server, and improving a disaster tolerance capability.

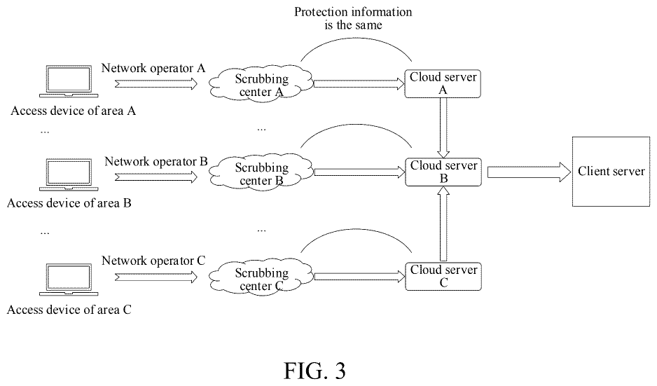

In some embodiments, the method for protecting against the abnormal network behavior may be applied to an application scenario shown in FIG. 3. Scrubbing centers and cloud servers are respectively deployed in area A, area B, and area C, and a client server is located in area B. The scrubbing centers in the areas and the cloud servers in the areas have the same protection information corresponding to the client server.

An access device of area A initiates a data request Q11; scrubbing center A of area A receives the data request Q11 forwarded by network operator A in area A; scrubbing center A scrubs, through protection information corresponding to a network address of the client server, a candidate data request Q12 corresponding to the network address in data request Q11, to obtain a scrubbed data request Q13, and forwards the scrubbed data request Q13 to cloud server A in area A; the cloud server A scrubs the scrubbed data request Q13 through the protection information, to obtain a target data request Q14; and cloud server A transmits the target data request Q14 to cloud server B, and cloud server B transmits the target data request Q14 to the client server.

An access device of area B initiates a data request Q21; scrubbing center B of area B receives the data request Q21 forwarded by network operator B in area B; scrubbing center B scrubs, through protection information, a candidate data request Q22 corresponding to a network address in data request Q21, to obtain a scrubbed data request Q23, and forwards the scrubbed data request Q23 to cloud server B in area B; cloud server B scrubs the scrubbed data request Q23 through the protection information, to obtain a target data request Q24; and cloud server B transmits the target data request Q14 to the client server.

Scrubbing center C and cloud server C in area C transmit, in the same manner as scrubbing center A and cloud server A, a target data request obtained through scrubbing to the client server.

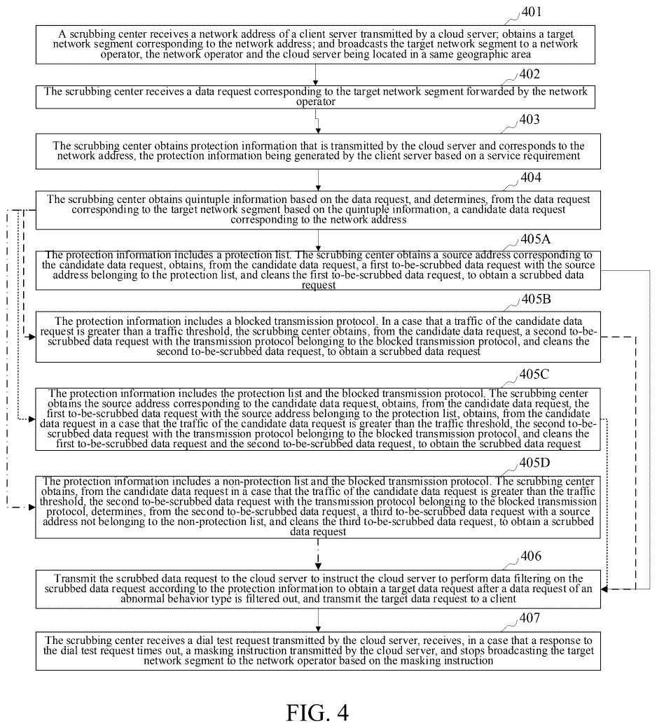

In some embodiments, as shown in FIG. 4, the method for protecting against the abnormal network behavior includes:

Operation 401: A scrubbing center receives a network address of a client server transmitted by a cloud server; obtains a target network segment corresponding to the network address; and broadcasts the target network segment to a network operator, the network operator and the cloud server being located in a same geographic area.

Operation 402: The scrubbing center receives a data request corresponding to the target network segment forwarded by the network operator.

In some embodiments, the client server binds its network address to the cloud server. The cloud server transmits the network address of the client server to the scrubbing center. The scrubbing center determines the target network segment based on the network address and the subnet mask of the network address. A router of the scrubbing center broadcasts the target network segment, so that the network operator forwards the data request with the IP address belonging to the target network segment to the scrubbing center. Since the network address of the client server belongs to the target network segment, the scrubbing center may receive the data request for accessing the client server.

Operation 403: The scrubbing center obtains protection information that is transmitted by the cloud server and corresponds to the network address, the protection information being generated by the client server based on a service requirement.

In some embodiments, the client server generates, based on the service requirement, the protection information corresponding to the network address. For example, a data request of an abnormal behavior type, which is received in the network address of the client server, includes a large number of data requests that belong to a UDP transmission protocol. Thus, the protection information may be configured to include a blocked transmission protocol. The blocked transmission protocol includes the UDP transmission protocol. The data requests of the UDP transmission protocol are filtered through the protection information. The scrubbing center receives the protection information transmitted by the cloud server, so that the scrubbing center and the cloud server have the same protection information.

Operation 404: The scrubbing center obtains quintuple information based on the data request, and determines, from the data request corresponding to the target network segment based on the quintuple information, a candidate data request corresponding to the network address.

In some embodiments, for the data request corresponding to the target network segment, the scrubbing center obtains the quintuple information of the data request, determines, based on the destination address included in the quintuple information, the candidate data request with the destination address that is the network address, and scrubs the candidate data request through the protection information to obtain the scrubbed data request.

Operation 405A: The protection information includes a protection list. The scrubbing center obtains a source address corresponding to the candidate data request, obtains, from the candidate data request, a first data request with the source address belonging to the protection list, and scrubs the first data request, to obtain a scrubbed data request.

The protection list includes a protection source address, and the protection source address is a source address that is not allowed to access the client server.

Operation 405B: The protection information includes a blocked transmission protocol. In response to that a traffic of the candidate data request is greater than a traffic threshold, the scrubbing center obtains, from the candidate data request, a second data request with the transmission protocol belonging to the blocked transmission protocol, and scrubs the second data request, to obtain a scrubbed data request.

The blocked transmission protocol may include: at least one of a UDP transmission protocol, a TCP transmission protocol, or an ICMP transmission protocol.

Operation 405C: The protection information includes the protection list and the blocked transmission protocol. The scrubbing center obtains the source address corresponding to the candidate data request, obtains, from the candidate data request, the first data request with the source address belonging to the protection list, obtains, from the candidate data request in response to that the traffic of the candidate data request is greater than the traffic threshold, the second data request with the transmission protocol belonging to the blocked transmission protocol, and scrubs the first data request and the second data request, to obtain the scrubbed data request.

Operation 405D: The protection information includes a non-protection list and the blocked transmission protocol. The scrubbing center obtains, from the candidate data request in response to that the traffic of the candidate data request is greater than the traffic threshold, the second data request with the transmission protocol belonging to the blocked transmission protocol, determines, from the second data request, a third data request with a source address not belonging to the non-protection list, and scrubs the third data request, to obtain a scrubbed data request.

Operation 406: The scrubbing center transmits the scrubbed data request to the cloud server to instruct the cloud server to perform data filtering on the scrubbed data request based on the protection information to obtain a target data request after a data request of an abnormal behavior type is filtered out, and transmits the target data request to the client server.

In some embodiments, the cloud server performs data filtering on the scrubbed data request through the protection information corresponding to the network address of the client server, to obtain the target data request, and the cloud server transmits the target data request to the client server through a cloud intra-network.

Operation 407: The scrubbing center receives a dial test request transmitted by the cloud server, receives, in response to that a response to the dial test request times out, a masking instruction transmitted by the cloud server, and stops broadcasting the target network segment to the network operator based on the masking instruction.

In some embodiments, the cloud server may periodically transmit a Ping request to the scrubbing center. The scrubbing center receives and makes a response to the Ping request. If the response made by the scrubbing center to the Ping request times out, it indicates that a link of the scrubbing center is abnormal, the cloud server transmits a masking instruction to the scrubbing center. The scrubbing center receives the masking instruction, and stops broadcasting the target network segment to the network operator based on the masking instruction.

In the foregoing embodiment, the scrubbing center receives the data request that is forwarded by the network operator and corresponds to the target network segment, and obtains the protection information corresponding to the network address of the client server, the protection information being generated by the client server based on the service requirement. The scrubbing center scrubs the data request through the protection information, and transmits the scrubbed data request to the cloud server. The cloud server performs data filtering on the scrubbed data request through the protection information, to obtain the target data request from which the data request of the abnormal behavior type is filtered out, and transmits the target data request to the client server. Both the scrubbing center and the cloud server perform the data scrubbing through the protection information, so that protection for the data request of the abnormal behavior type adapts to an actual service requirement of the client server. Thus, the data request of the abnormal behavior type can be effectively scrubbed at the scrubbing center, and then the cloud server performs the secondary scrubbing on the scrubbed data request to filter out a small number of data requests of the abnormal behavior type that pass through the scrubbing center, to obtain the target data request from which the data request of the abnormal behavior type is filtered out. This ensures the service stability of the client server and improves the effect of protecting against the abnormal network behavior. In addition, in the related art, router broadcasting is performed by the network operator, and a router broadcasting method and a router broadcasting area are both in fixed modes, and cannot be adjusted for the service requirement of the client server. In the foregoing embodiment, the router broadcasting is performed by the scrubbing center on the network operator, so that the router broadcasting method and the router broadcasting area can both be adjusted based on the service requirement of the client, to satisfy a service access delay requirement of the client server.

Although the steps are displayed sequentially according to the instructions of the arrows in the flowcharts of the embodiments, these steps are not necessarily performed sequentially according to the sequence instructed by the arrows. Unless otherwise explicitly specified in the present disclosure, execution of the steps is not strictly limited, and the steps may be performed in other sequences. Moreover, at least some of the steps in the flowcharts of the various embodiments may include a plurality of steps or a plurality of stages. These steps or stages are not necessarily performed at the same moment but may be performed at different moments. Execution of these steps or stages is not necessarily performed in sequence, but may be performed in turn or alternately with other steps or at least some of steps or stages of other steps.

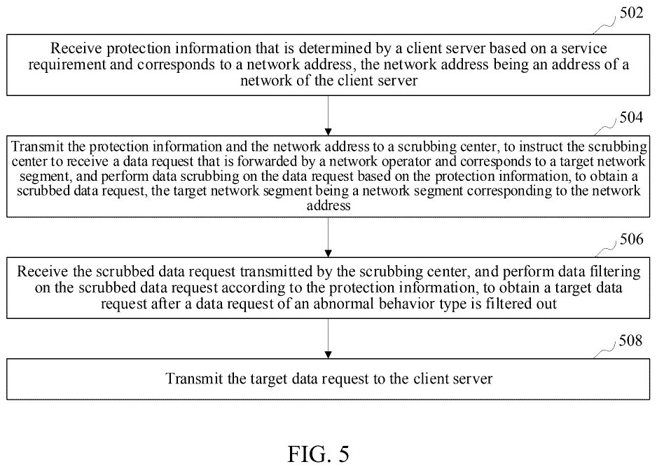

In some embodiments, as shown in FIG. 5, a method for protecting against an abnormal network behavior is provided. The method being performed by the cloud server in FIG. 1 is taken as an example for explanation, including the following operations:

Operation 502: Receive protection information that is determined by a client server based on a service requirement and corresponds to a network address, the network address being an address of a network of the client server.

In some embodiments, the client server configures, based on a service requirement, the protection information corresponding to the network address, and transmits the protection information to the cloud server. The cloud server receives the protection information transmitted by the client server.

In some embodiments, a client may perform a configuration operation on a protection configuration page of a protection platform, to transmit configuration information to the client server, and the client server generates the protection information corresponding to the network address based on the configuration information. The protection information may include but not limited to: a protection list, a blocked transmission protocol, and port information.

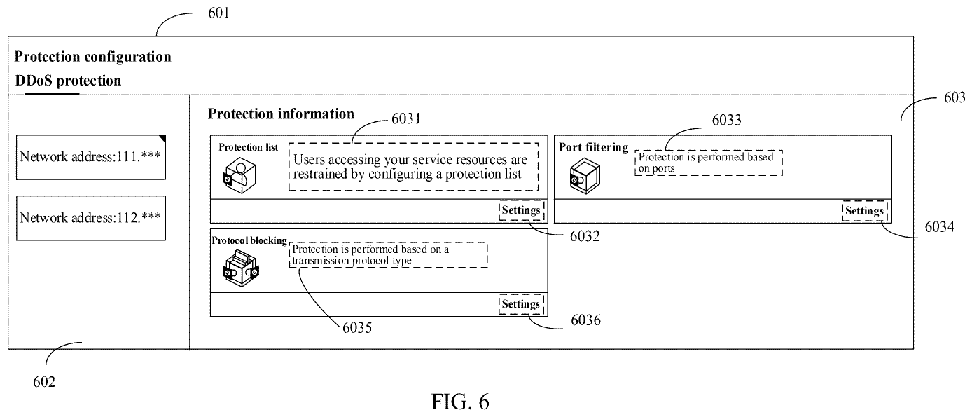

As shown in FIG. 6, the protection configuration page 601 includes: a network address selection area 602 for DDoS protection and a configuration area 603 for DDoS protection. The network address selection area 602 includes the network address of the client server. The configuration area 603 includes a configuration area corresponding to each piece of protection information, for example, including: a protection list configuration area, a protocol blocking configuration area, and a port filtering configuration area. When the network address of the client server in the protection configuration page is in a selected state, each piece of protection information may be configured through the configuration area 603, to obtain the protection information corresponding to the network address.

For example, the network address of the client server is 111.***, and the network address is in a selected state. The protection list configuration area includes protection function description information 6031 of protection list. The client displays a setting page of the protection list in response to a trigger operation performed on a setting control 6032 in the protection list configuration area. A protection source address may be added into the setting page of the protection list. The port filtering configuration area includes protection function description information 6033 of port filtering. The client displays a setting page of port filtering configuration in response to a trigger operation performed on a setting control 6034 in the port filtering configuration, and source port information for filtering may be added into the setting page of port filtering configuration. The protocol blocking configuration area includes protection function description information 6035 of protocol blocking. The client displays a setting page of protocol blocking in response to a trigger operation performed on a setting control 6036 in the protocol blocking configuration area. A blocked transmission protocol may be added into the setting page of protocol blocking.

In addition, Content displayed on the protection configuration page in FIG. 6 is merely an example of the present disclosure. In actual application, the protection configuration page may further include a configuration area of other protection information and other content related to DDoS protection. This is not limited in this embodiment of the present disclosure.

The client configures each piece of protection information on the protection configuration page to obtain configuration information and transmits the configuration information to the client server, and the client server generates the protection information corresponding to the network address based on the configuration information, and transmits the protection information corresponding to the network address to the cloud server.

Operation 504: Transmit the protection information and the network address to a scrubbing center, to instruct the scrubbing center to receive a data request that is forwarded by a network operator and corresponds to a target network segment, and perform data scrubbing on the data request based on the protection information, to obtain a scrubbed data request, the target network segment being a network segment corresponding to the network address.

In some embodiments, the cloud server transmits the network address and the corresponding protection information to the scrubbing center. After receiving the network address and the corresponding protection information which are transmitted by the cloud server, the scrubbing center receives the data request forwarded by the network operator.

In some embodiments, the transmitting the protection information and the network address to a scrubbing center, to instruct the scrubbing center to receive a data request that is forwarded by a network operator and corresponds to a target network segment includes:
transmitting the protection information and the network address to the scrubbing center, to instruct the scrubbing center to obtain the target network segment corresponding to the network address, broadcasting the target network segment to the network operator, and receive the data request that is forwarded by the network operator and corresponds to the target network segment. The network operator and the cloud server are located in a same geographic area.

In some embodiments, for a specific process in which the scrubbing center obtains the target network segment based on the network address, broadcasts the target network segment to the network operator, and receives the data request that is forwarded by the network operator and corresponds to the target network segment, refer to the description in which the scrubbing center receives the data request that is forwarded by the network operator and corresponds to the target network segment in the foregoing embodiment.

The process in which the scrubbing center receives the data request that is forwarded by the operator and corresponds to the target network segment, and performs the data scrubbing on the data request based on the protection information, to obtain the scrubbed data request is the same as the process of operation 204 in the foregoing embodiment. Therefore, for a process of operation 504, refer to the detailed description of operation 204 in the foregoing embodiment.

Operation 506: Receive the scrubbed data request transmitted by the scrubbing center, and perform data filtering on the scrubbed data request based on the protection information, to obtain a target data request after a data request of an abnormal behavior type is filtered out.

In some embodiments, the protection information includes a protection list, and the cloud server performs data filtering on the scrubbed data request based on the protection information, to obtain a target data request after a data request of an abnormal behavior type is filtered out, which includes: The cloud server obtains a source address corresponding to the scrubbed data request; obtains, from the scrubbed data request, a fourth data request with the source address belonging to the protection list; and scrubs the fourth data request to obtain the target data request from which the data request of the abnormal behavior type is filtered out.

In some embodiments, the protection information includes a blocked transmission protocol. The cloud server performs data filtering on the scrubbed data request based on the protection information, to obtain a target data request after a data request of an abnormal behavior type is filtered out, which includes: The cloud server obtains, from the scrubbed data request in response to that a traffic of the candidate data request is greater than a traffic threshold, a fifth data request with a transmission protocol belonging to the blocked transmission protocol; and scrubs the fifth data request to obtain the target data request from which the data request of the abnormal behavior type is filtered out.

In some embodiments, the protection information includes a protection list and a blocked transmission protocol. The cloud server performs data filtering on the scrubbed data request based on the protection information, to obtain a target data request after a data request of an abnormal behavior type is filtered out, which includes: The cloud server obtains a source address corresponding to the scrubbed data request; obtains, from the scrubbed data request, a fourth data request with the source address belonging to the protection list; and obtains, from the scrubbed data request in response to that a traffic of the scrubbed data request is greater than a traffic threshold, a fifth data request with the transmission protocol belonging to the blocked transmission protocol, and scrubs the fourth data request and the fifth data request, to obtain the target data request after a data request of an abnormal behavior type is filtered out.

In some embodiments, the protection information includes a non-protection list and a blocked transmission protocol. The cloud server performs data filtering on the scrubbed data request based on the protection information, to obtain a target data request after a data request of an abnormal behavior type is filtered out, which includes: The cloud server obtains, from the scrubbed data request in response to that a traffic of the candidate data request is greater than a traffic threshold, a fifth data request with a transmission protocol belonging to the blocked transmission protocol; and determines, from the fifth data request, a sixth data request with the source address not belonging to the non-protection list. The scrubbing center scrubs the sixth data request to obtain the scrubbed data request.

Operation 508: Transmit the target data request to the client server.

In the foregoing method for protecting against the abnormal network behavior, the cloud server obtains the protection information corresponding to the network address of the client server, and transmits the protection information and the network address to the scrubbing center; the scrubbing center receives the data request that is forwarded by the operator and corresponds to the target network; the scrubbing center scrubs the data request through the protection information; the protection information is configured by the client server based on the service requirement, so that the data request of the abnormal behavior type can be effectively cleared away at the scrubbing center; the cloud server performs secondary scrubbing on the scrubbed data request through the protection information, to filter out a small number of data requests of the abnormal behavior type, which are not cleared away by the scrubbing center, to obtain the target data request from which the data requests of the abnormal behavior type are filtered out, thereby ensuring the service stability of the client server and improving the effect of protecting against the abnormal network behavior.

In some embodiments, the method for protecting against the abnormal network behavior further includes: transmitting a dial test request to the scrubbing center; and transmitting a masking instruction to the scrubbing center in response to that a response made by the scrubbing center to the dial test request times out, to instruct the scrubbing center to stop broadcasting the target network segment to the network operator.

In some embodiments, the cloud server may periodically transmit a dial test request to the scrubbing center. The scrubbing center receives and makes a response to the dial test request. In response to that the response made by the scrubbing center to the dial test request times out, it is determined that a link of the scrubbing center is abnormal, the cloud server transmits a masking instruction to the scrubbing center. The scrubbing center receives the masking instruction, and stops broadcasting the target network segment to the network operator based on the masking instruction.

In some embodiments, after transmitting the masking instruction to the scrubbing center, the cloud server transmits a broadcasting instruction to another scrubbing center, to instruct the another scrubbing center to broadcast the target network segment that is broadcast by the scrubbing center receiving the masking instruction, so that the network operator forwards the data request corresponding to the target network segment to the another scrubbing center.

In the related art, a data request is scrubbed through a scrubbing node inside a network operator, and the cloud server cannot determine in time that a link of the scrubbing node of the network operator is abnormal. As a result, the data request cannot be normally scheduled, and the service stability of the client server is affected. In the foregoing embodiment, the cloud server may perform a dial test on the scrubbing center, and determine a link state of the scrubbing center in time. When the link of the scrubbing center is abnormal, the cloud server controls, through the masking instruction, the scrubbing center to stop broadcasting the target network segment to the network operator, so that the network operator does not forward the data request to a scrubbing center with a faulty link and the network operator may forward the data request to another scrubbing center, thereby achieving scheduling of the data request, ensuring the service stability of the client server, and improving a disaster tolerance capability.

In some embodiments, before the receiving protection information that is determined by a client server based on a service requirement and corresponds to a network address, the method further includes: establishing, in response to an association request transmitted by the client server, an association relationship between the network address of the client server and the cloud server, the network address being an address that is requested based on a protection service possessed by the client server and has a protection attribute.

In some embodiments, a protection service of the client server may be purchased on a protection platform by using a client; a network address having a protection attribute is requested based on the protection service of the client server; and the network address belongs to an elastic IP (EIP), and an association relationship is established between the requested network address and the server.

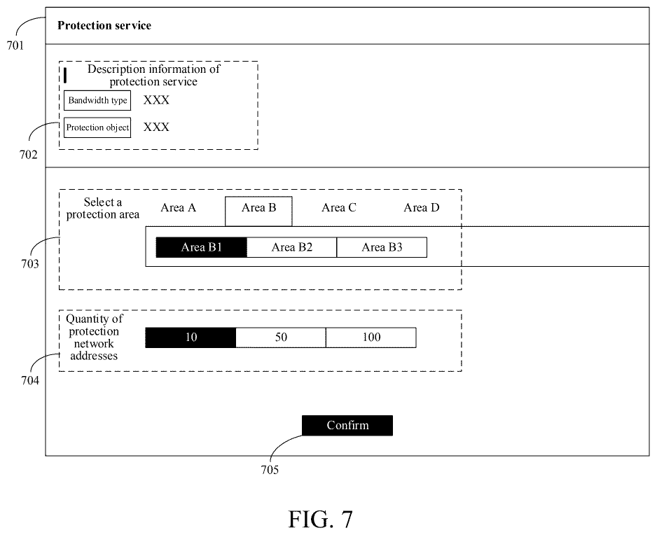

For example, as shown in FIG. 7, a protection service is purchased on a protection service purchase page 701 of a protection platform based on a service requirement of the client server. The protection service purchase page 701 includes description information 702 of protection service, and the description information 702 of protection service includes a bandwidth type and a protection object of the protection service. The protection service purchase page includes a protection area selection control 703, for example, in FIG. 7, including selection controls respectively corresponding to area A, area B, area C, and area D. A protection area may be selected based on an area in which the network address of the client server is located. The protection service purchase page 701 further includes a protection network address quantity selection control 704, which may select a quantity of protection network addresses based on the service requirement. The client completes the purchase of the protection service in response to a trigger operation performed on a purchase confirm control 705 on the protection service purchase page 701, so that the client server has the protection service. In addition, FIG. 7 is only an example of the protection service purchase page. The protection service purchase page may further include other related content, such as a validity period of the protection service and a bandwidth of the protection service. Specific content of the protection service purchase page is not limited in this embodiment of the present disclosure.

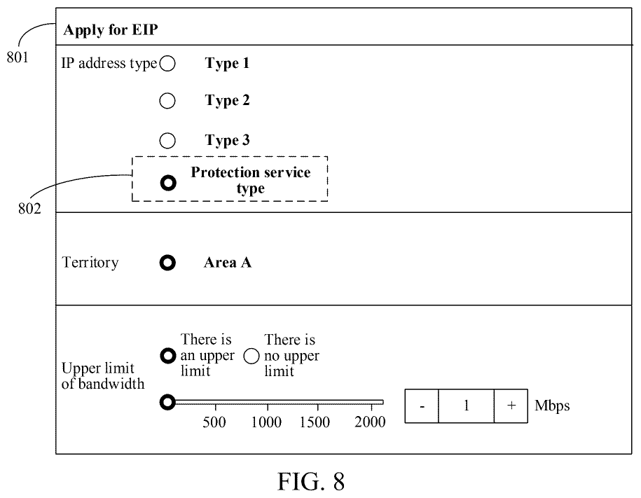

As shown in FIG. 8, an EIP of a type corresponding to the purchased protection service is selected on an EIP applying page 801 of the protection platform, and a selection control 802 corresponding to the protection service type is in a selected state, thus protecting against a DDoS-type attack through the protection service type. A service area corresponding to the protection service is selected. For example, in FIG. 8, area A is selected as the service area corresponding to the protection service, and an upper bandwidth limit corresponding to the protection service may further be set on the EIP applying page 801 of the protection platform. In addition, the EIP applying page shown in FIG. 8 is merely an example. In actual application, the EIP applying page may further include more related content, or may be presented in another form. This is not limited in this embodiment of the present disclosure.

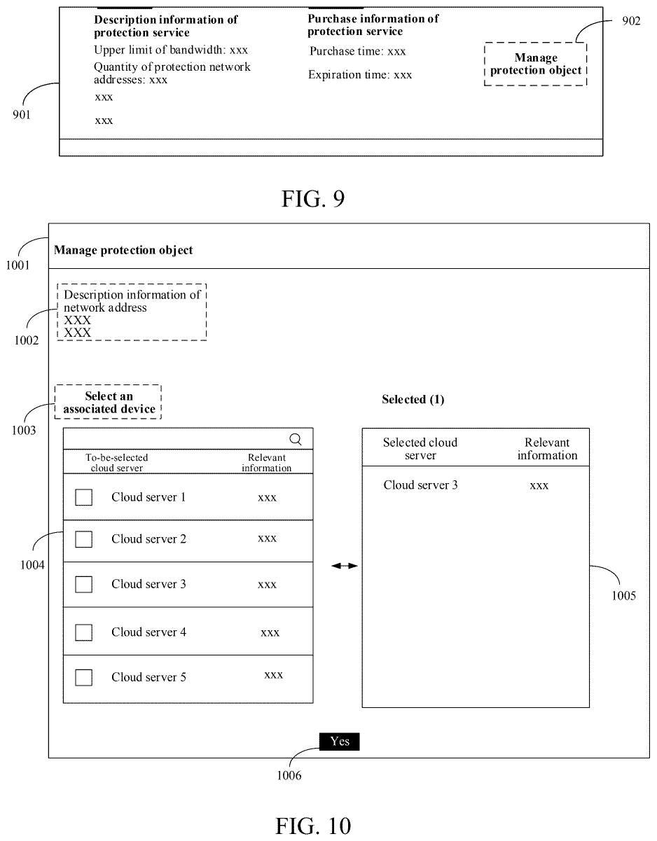

After the EIP application is completed, the network address with the protection attribute is obtained, and then the protection service is configured through a protection service management page of the protection platform. As shown in FIG. 9, a protection service management page 901 includes description information of protection service, purchase information of protection service, description information of network address, and a protection object management control 902. An association operation of establishing an association relationship between the network address of the client server and the cloud server is performed through the protection object management control 902. In addition, the protection service management page shown in FIG. 9 is merely an example. In actual application, the protection service management page may further include more related content, or may be presented in another form. This is not limited in this embodiment of the present disclosure.

The client displays a protection object management page in response to a trigger operation performed on a protection object management control. As shown in FIG. 10, a protection object management page 1001 includes description information 1002 of network address, an associated device selection control 1003, a to-be-selected device area 1004, a selected device area 1005, and a confirm control 1006. The client displays an associated device type list in the to-be-selected device area 1004 in response to a trigger operation performed on the associated device type selection control 1003. The associated device type list includes to-be-selected cloud servers and corresponding related information. The client displays a selected cloud server and related information in the selected device area 1005 in response to a selection operation performed on a to-be-selected cloud server among the to-be-selected cloud servers. The client server transmits an association request to the client server in response to a trigger operation performed on the confirm control 1006 on the protection object management page 1001. The client server forwards the association request to the selected cloud server, and the cloud server establishes an association relationship between the network address of the client server and the cloud server in response to the association request.

In the foregoing embodiment, the cloud server establishes the association relationship between the network address of the client server and the cloud server based on the association request transmitted by the client server, so that the cloud server can communicate with a public network through the network address, scrub the scrubbed data request through the protection information corresponding to the network address, and transmit the target data request to the client server.

In some embodiments, the method for protecting against the abnormal network behavior further includes: receiving scrubbing information transmitted by the scrubbing center after the scrubbing center performs the data scrubbing on the data request; obtaining an abnormal behavior type, a quantity of requests corresponding to the abnormal behavior type, and abnormal behavior time corresponding to the abnormal behavior type based on the scrubbing information in response to a protection overview instruction transmitted by the client server; and transmitting the abnormal behavior type, the quantity of requests corresponding to the abnormal behavior type, and the abnormal behavior time corresponding to the abnormal behavior type to the client server, to instruct the client server to transmit the abnormal behavior type, the quantity of requests corresponding to the abnormal behavior type, and the abnormal behavior time corresponding to the abnormal behavior type to a client, for enabling the client to display a protection overview page according to the abnormal behavior type, the quantity of requests corresponding to the abnormal behavior type, and the abnormal behavior time corresponding to the abnormal behavior type to the client server.

The protection overview instruction may be transmitted by the client to the client server, and transmitted to the cloud server through the client server.

The scrubbing information includes the abnormal behavior type corresponding to performing the data scrubbing on the data request, the quantity of requests corresponding to the abnormal behavior type, and request time corresponding to the abnormal behavior type. The abnormal behavior type includes, but is not limited to: a UDP-flood type, a TCP-flood type, and an ICMP-flood type. The quantity of requests corresponding to the abnormal behavior type is a quantity of data requests of the abnormal behavior type, which are scrubbed by the scrubbing center, and the abnormal behavior time is a moment when the scrubbing center identifies the abnormal behavior type.

In some embodiments, after performing the data scrubbing on the data request, the scrubbing center obtains scrubbing information corresponding to this protection, and transmits the scrubbing information to the cloud server. The client transmits a protection overview instruction to the client server in response to a trigger operation performed on a protection overview control on the protection service control page. The client server forwards the protection overview instruction to the cloud server. In response to the protection overview instruction, the cloud server transmits an abnormal behavior type, a corresponding quantity of requests, and corresponding abnormal behavior time to the client server based on the scrubbing information. The client server transmits the abnormal behavior type, the corresponding quantity of requests, and the corresponding abnormal behavior time to the client. The client displays a protection overview page based on the abnormal behavior type, the corresponding quantity of requests, and the corresponding abnormal behavior time.

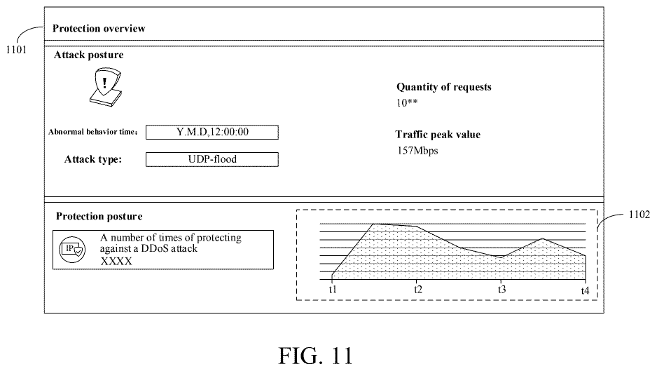

For example, as shown in FIG. 11, a protection overview page 1101 includes an attack posture area. The attack posture area includes: The abnormal behavior type is a UDP-flood type. The abnormal behavior time corresponding to the UDP-flood type is: Y.M.D, 12:00:00, and the quantity of requests corresponding to the UDP-flood type is: 10**. The attack posture area may further include other related information of an DDoS attack, such as a traffic peak value of the DDoS attack.

In some embodiments, the protection overview page 1101 further includes a protection posture area. The protection posture area includes: a number of times of protecting against the DDoS attack, a number of DDoS attacks attacking the network address of the client server, and time of each DDoS attack. The number of DDoS attacks and the time of each DDoS attack may be displayed in a protection trend fold line chart. The protection trend fold line chart is shown in 1102 in FIG. 11.

In some embodiments, in response to that the protection service provided by the client server asks for a plurality of network addresses having protection attributes, the protection overview area further includes a quantity of the network addresses having the protection attributes, and a quantity of network addresses that have been attacked by the DDoS attack among the plurality of network addresses having the protection attributes.

In the foregoing embodiment, the cloud server transmits the abnormal behavior type, the corresponding quantity of requests, and the abnormal behavior time to the client server. The client server transmits the abnormal behavior type, the corresponding quantity of requests, and the abnormal behavior time to the client. The client may view a specific situation of protecting against the DDoS attack on the protection overview page, so that the client may browse data of protecting against the abnormal network behavior more intuitively.

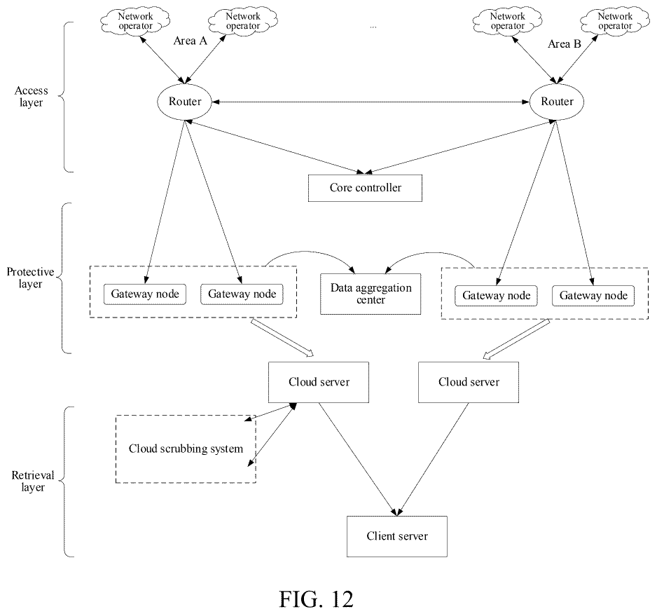

In some embodiments, the method for protecting against the abnormal network behavior can be applied to a scenario shown in FIG. 12. A network operator, a scrubbing center, a cloud server, and a client server constitute an architecture for protecting against an abnormal network behavior. The architecture for protecting against the abnormal network behavior includes an access layer, a protection layer, and a retrieval layer. The access layer includes the network operator, a router of the scrubbing center, and a core controller of the cloud server. The protection layer includes gateway nodes of the scrubbing center and a data aggregation center. The retrieval layer includes the client server, and a cloud scrubbing system of the cloud server.

For the access layer, the router of the scrubbing center is connected to the network operator, and broadcasts a target network segment to the network operator. The broadcasting may be performed through a boundary gateway protocol (BGP) routing protocol. The BGP is an inter-autonomous system routing protocol, and may monitor a routing loop and make a decision on routing based on a performance priority and a policy constraint. The router communicates with the core controller through an interface. The core controller may control the target network segment broadcast by the router. For example, in response to that there is an abnormal link in the scrubbing center, the core controller may control the router to stop broadcasting the target network segment.

For the protection layer, protection information is integrated into the gateway nodes of the scrubbing center in a form of .so library. The gateway nodes of the scrubbing center aggregate candidate data requests corresponding to the network address to one gateway node. The candidate data requests corresponding to the network address are scrubbed through the gateway nodes of the scrubbing center. After scrubbing the candidate data requests, the gateway nodes report scrubbing information to a data aggregation center. The data aggregation center may transmit the scrubbing information to the cloud server, and the cloud server further transmits the scrubbing information to the client server.

For the retrieval layer, the gateway nodes of the scrubbing center retrieve the scrubbed data requests to the cloud server, and the scrubbed data requests are scrubbed based on the protection information through the cloud scrubbing system of the cloud server, and then a target data request obtained through the scrubbing is transmitted to the client server.

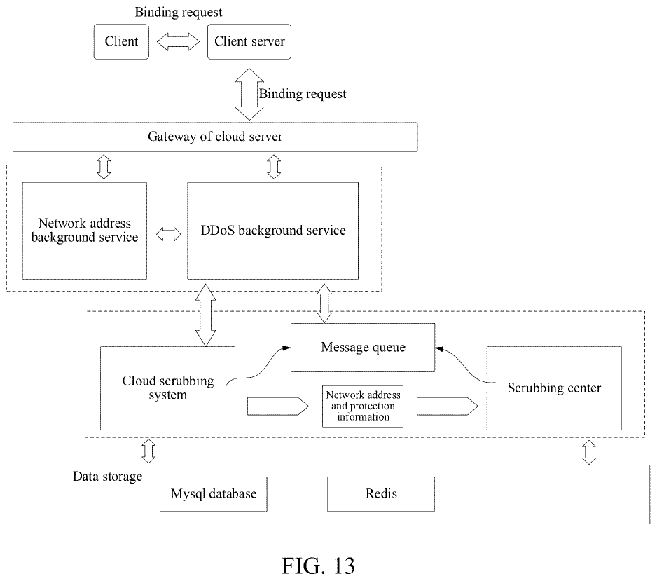

In some embodiments, the method for protecting against the abnormal network behavior can be applied to a scenario shown in FIG. 13. A client, a client server, a scrubbing center, and a cloud server jointly perform the method for protecting against the abnormal network behavior The cloud server includes a gateway, a DDoS background service, a network address background service, and a cloud scrubbing system.

The client may configure a protection service of the client server on a protection platform. The client purchases the protection service from the protection platform, requests a network address having a protection attribute based on the protection service of the client server, performs a binding operation for the protection service and the network address. The client generates a binding request based on the binding operation, and transmits the binding request to the client service. The client server transmits the binding request to the cloud server through the gateway of the cloud server. Protection service information included in the binding request and the network address are checked through the DDoS background service and the network address background service. The cloud server binds the protection service to the network address in response to that it is determined that the network address is the network address that is requested based on the protection service and has the protection attribute.

The cloud server obtains protection information corresponding to a network address of the client server, and transmits the network address and the corresponding protection information to a cloud scrubbing system of the cloud server through the DDoS background service; and the cloud scrubbing system transmits the network address and the corresponding protection information to the scrubbing center, so that the scrubbing center and the cloud server both have the protection information corresponding to the network address of the client server. The cloud scrubbing system and the scrubbing center may transmit the scrubbing information to the DDoS background service through a message queue.

The cloud scrubbing system and the scrubbing center may store the protection information and related data for protecting against a DDoS attack into a Mysql database, so as to improve the data query efficiency through the Mysql database. The Mysql database is a relational database. The cloud scrubbing system and the scrubbing center may cache a related request for protecting against the DDoS attack into Redis. Redis is a high-performance open-source non-relational database written in C language.

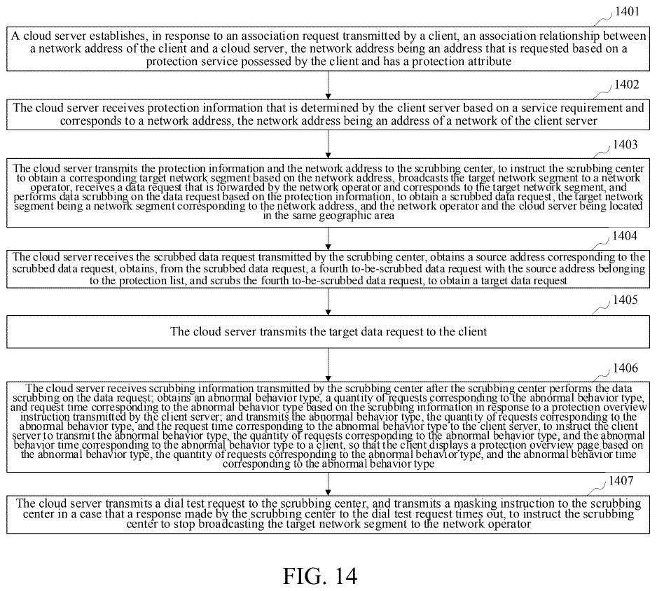

In some embodiments, as shown in FIG. 14, the method for protecting against the abnormal network behavior includes:

Operation 1401: A cloud server establishes, in response to an association request transmitted by a client server, an association relationship between a network address of a client server and the cloud server. The network address is an address that is requested based on a protection service possessed by the client server and has a protection attribute.

In some embodiments, a client purchases a protection service of the client server on a protection platform and requests a network address based on the protection service of the client server. The client transmits an association request to the client server. The client server forwards the association request to a selected cloud server. The cloud server establishes an association relationship between the network address of the client server and the cloud server in response to the association request.

Operation 1402: The cloud server receives protection information that is determined by the client server based on a service requirement and corresponds to a network address, the network address being an address of a network of the client server.

The protection information may include but not limited to: a protection list, a blocked transmission protocol, and port information.

Operation 1403: The cloud server transmits the protection information and the network address to the scrubbing center, to instruct the scrubbing center to obtain a corresponding target network segment based on the network address, broadcasts the target network segment to a network operator, receives a data request that is forwarded by the network operator and corresponds to the target network segment, and performs data scrubbing on the data request based on the protection information, to obtain a scrubbed data request, the target network segment being a network segment corresponding to the network address, and the network operator and the cloud server being located in a same geographic area.

In some embodiments, the cloud server transmits the protection information and the network address to the scrubbing center, and the scrubbing center obtains the corresponding target network segment based on the network address, broadcasts the target network segment to the network operator, and receives the data request that is forwarded by the network operator and corresponds to the target network segment.

Operation 1404: The cloud server receives the scrubbed data request transmitted by the scrubbing center, obtains a source address corresponding to the scrubbed data request, obtains, from the scrubbed data request, a fourth data request with the source address belonging to the protection list, and scrubs the fourth data request, to obtain a target data request.

In some embodiments, the protection information includes a blocked transmission protocol. The cloud server obtains, from the scrubbed data request in response to that a traffic of the candidate data request is greater than a traffic threshold, a fifth data request with a transmission protocol belonging to the blocked transmission protocol; and scrubs the fifth data request to obtain the target data request from which the data request of the abnormal behavior type is filtered out.

Operation 1405: The cloud server transmits the target data request to the client server.

Operation 1406: The cloud server receives scrubbing information transmitted by the scrubbing center after the scrubbing center performs the data scrubbing on the data request; obtains an abnormal behavior type, a quantity of requests corresponding to the abnormal behavior type, and request time corresponding to the abnormal behavior type based on the scrubbing information in response to a protection overview instruction transmitted by the client server; and transmits the abnormal behavior type, the quantity of requests corresponding to the abnormal behavior type, and the request time corresponding to the abnormal behavior type to the client server, to instruct the client server to transmit the abnormal behavior type, the quantity of requests corresponding to the abnormal behavior type, and the abnormal behavior time corresponding to the abnormal behavior type to a client, so that the client displays a protection overview page based on the abnormal behavior type, the quantity of requests corresponding to the abnormal behavior type, and the abnormal behavior time corresponding to the abnormal behavior type.

The protection overview instruction may be transmitted by the client to the client server and then transmitted to the cloud server through the client server. The scrubbing information includes the abnormal behavior type corresponding to performing the data scrubbing on the data request, the quantity of requests corresponding to the abnormal behavior type, and the request time corresponding to the abnormal behavior type. The abnormal behavior type includes, but is not limited to: a UDP-flood type, a TCP-flood type, and an ICMP-flood type. The quantity of requests corresponding to the abnormal behavior type is a quantity of data requests of the abnormal behavior type, which are scrubbed by the scrubbing center, and the abnormal behavior time is a moment when the scrubbing center identifies the abnormal behavior type.

In some embodiments, after performing the data scrubbing on the data request, the scrubbing center obtains scrubbing information corresponding to this protection, and transmits the scrubbing information to the cloud server. The client transmits a protection overview instruction to the client server in response to a trigger operation performed on a protection overview control on the protection service control page. The client server forwards the protection overview instruction to the cloud server. In response to the protection overview instruction, the cloud server transmits an abnormal behavior type, a corresponding quantity of requests, and corresponding abnormal behavior time to the client server based on the scrubbing information. The client server transmits the abnormal behavior type, the corresponding quantity of requests, and the corresponding abnormal behavior time to the client. The client displays a protection overview page based on the abnormal behavior type, the corresponding quantity of requests, and the corresponding abnormal behavior time.

Operation 1407: The cloud server transmits a dial test request to the scrubbing center, and transmits a masking instruction to the scrubbing center in response to that a response made by the scrubbing center to the dial test request times out, to instruct the scrubbing center to stop broadcasting the target network segment to the network operator.

In some embodiments, the cloud server may periodically transmit a dial test request to the scrubbing center. The scrubbing center receives and makes a response to the dial test request. In response to that the response made by the scrubbing center to the dial test request times out, it is determined that a link of the scrubbing center is abnormal, the cloud server transmits a masking instruction to the scrubbing center. The scrubbing center receives the masking instruction, and stops broadcasting the target network segment to the network operator based on the masking instruction.

In the foregoing method for protecting against the abnormal network behavior, the cloud server obtains the protection information corresponding to the network address of the client server, and transmits the protection information and the network address to the scrubbing center; the scrubbing center receives the data request that is forwarded by the operator and corresponds to the target network; the scrubbing center scrubs the data request through the protection information; the protection information is configured by the client server based on the service requirement, so that the data request of the abnormal behavior type can be effectively cleared away at the scrubbing center; the cloud server performs secondary scrubbing on the scrubbed data request through the protection information, to filter out a small number of data requests of the abnormal behavior type, which are not cleared away by the scrubbing center, to obtain the target data request from which the data requests of the abnormal behavior type are filtered out, thereby ensuring the service stability of the client server and improving the effect of protecting against the abnormal network behavior.

Although the steps are displayed sequentially according to the instructions of the arrows in the flowcharts of the embodiments, these steps are not necessarily performed sequentially according to the sequence instructed by the arrows. Unless otherwise explicitly specified in the present disclosure, execution of the steps is not strictly limited, and the steps may be performed in other sequences. Moreover, at least some of the steps in the flowcharts of the various embodiments may include a plurality of steps or a plurality of stages. These steps or stages are not necessarily performed at the same moment but may be performed at different moments. Execution of these steps or stages is not necessarily performed in sequence, but may be performed in turn or alternately with other steps or at least some of steps or stages of other steps.

Based on the same inventive concept, an embodiment of the present disclosure further provides an apparatus for protecting against an abnormal network behavior to implement the above method for protecting against an abnormal network behavior. An implementation solution provided by the apparatus for resolving a problem is similar to the implementation solution recorded in the foregoing method. Therefore, for specific limitations on one or more following embodiments of the apparatus for protecting against an abnormal network behavior, refer to the limitations on the foregoing method for protecting against an abnormal network behavior. Details are not described here again.

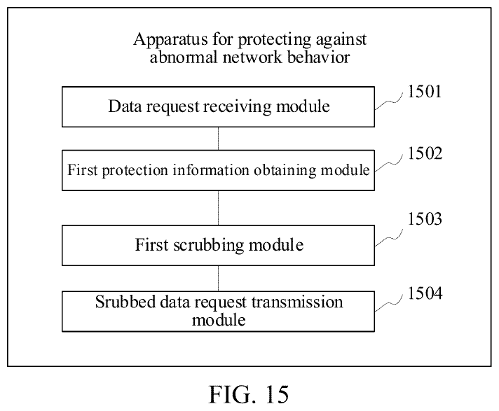

In an embodiment, as shown in FIG. 15, an apparatus for protecting against an abnormal network behavior is provided, including: a data request receiving module 1501, a first protection information obtaining module 1502, a first scrubbing module 1503, and a scrubbed data request transmission module 1504.

The data request receiving module 1501 is configured to receive a data request corresponding to a target network segment forwarded by a network operator, the target network segment being a network segment corresponding to a network address of a client server;

the first protection information obtaining module 1502 is configured to obtain protection information corresponding to the network address, the protection information being generated by the client server based on a service requirement;
the first scrubbing module 1503 is configured to perform data scrubbing on the data request based on the protection information to obtain a scrubbed data request; and
the scrubbed data request transmission module 1504 is configured to transmit the scrubbed data request to a cloud server to instruct the cloud server to perform data filtering on the scrubbed data request according to the protection information to obtain a target data request after a data request of an abnormal behavior type is filtered out, and transmit the target data request to the client server.

In some embodiments, the apparatus for protecting against the abnormal network behavior further includes:
a target network segment broadcasting module, configured to: receive the network address of the client server transmitted by the cloud server, obtain the target network segment corresponding to the network address, and broadcast the target network segment to the network operator. The network operator and the cloud server are located in a same geographic area.

In some embodiments, the apparatus for protecting against the abnormal network behavior further includes:
a first dial test module, configured to: receive a dial test request transmitted by the cloud server; receive, in response to that a response to the dial test request times out, a masking instruction transmitted by the cloud server; and stop broadcasting the target network segment to the network operator based on the masking instruction.

In some embodiments, the first protection information obtaining module 1502 is specifically configured to receive protection information corresponding to the network address transmitted by the cloud server.

In some embodiments, the first scrubbing module 1503 includes:
a candidate data request determination unit, configured to: obtain quintuple information based on the data request; and determine, from the data request corresponding to the target network segment based on the quintuple information, a candidate data request corresponding to the network address; and
a data scrubbing unit, configured to scrub the candidate data request based on the protection information, to obtain the scrubbed data request.

In some embodiments, the protection information includes a protection list. The data scrubbing unit is specifically configured to: obtain a source address corresponding to the candidate data request; obtain, from the candidate data request, a first data request with the source address belonging to the protection list; and scrub the first data request to obtain the scrubbed data request.

In some embodiments, the protection information includes a blocked transmission protocol. The data scrubbing unit is specifically configured to: obtain, from the candidate data request in response to that a traffic of the candidate data request is greater than a traffic threshold, a second data request with a transmission protocol belonging to the blocked transmission protocol; and scrub the second data request to obtain the scrubbed data request.

In some embodiments, the protection information includes a protection list and a blocked transmission protocol. The data scrubbing unit is specifically configured to: obtain a source address corresponding to the candidate data request; obtain, from the candidate data request, a first data request with the source address belonging to the protection list; obtain, from the candidate data request in response to that a traffic of the candidate data request is greater than a traffic threshold, a second data request with a transmission protocol belonging to the blocked transmission protocol; and scrub the first data request and the second data request to obtain the scrubbed data request.

In some embodiments, the protection information includes a non-protection list and a blocked transmission protocol. The data scrubbing unit is specifically configured to:
obtain, from the candidate data request in response to that a traffic of the candidate data request is greater than a traffic threshold, a second data request with a transmission protocol belonging to the blocked transmission protocol; determine, from the second data request, a third data request with the source address not belonging to the non-protection list; and scrub the third data request to obtain the scrubbed data request.

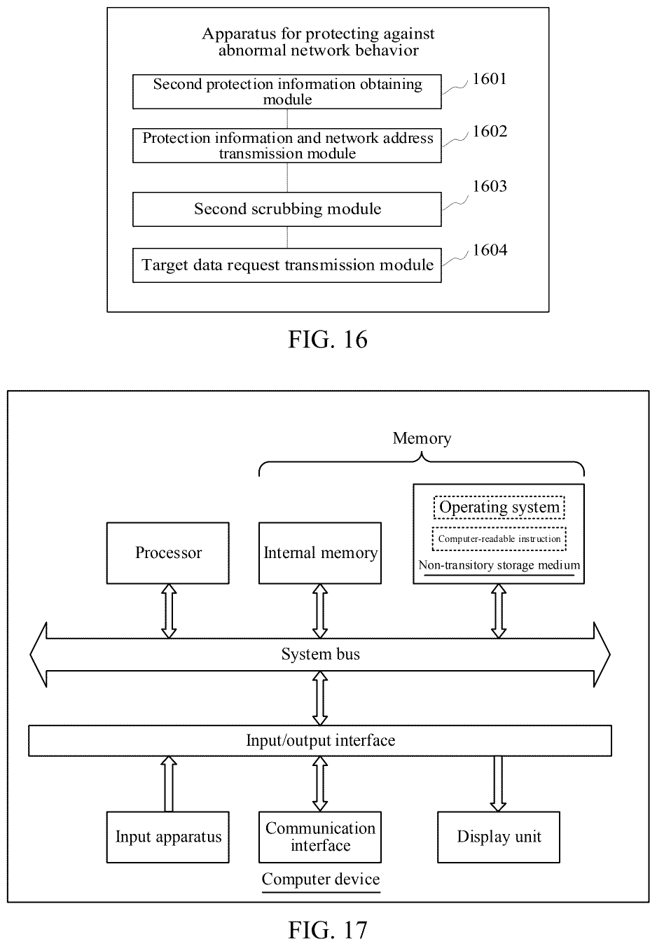

In an embodiment, as shown in FIG. 16, an apparatus for protecting against an abnormal network behavior is provided, including: a second protection information obtaining module 1601, a protection information and network address transmission module 1602, a second scrubbing module 1603, and a target data request transmission module 1604.

The second protection information obtaining module 1601 is configured to receive protection information that is determined by a client server based on a service requirement and corresponds to a network address, the network address being an address of a network of the client server;
the protection information and network address transmission module 1602 is configured to: transmit the protection information and the network address to a scrubbing center, to instruct the scrubbing center to receive a data request that is forwarded by a network operator and corresponds to a target network segment, and perform data scrubbing on the data request based on the protection information, to obtain a scrubbed data request, the target network segment being a network segment corresponding to the network address;
the second scrubbing module 1603 is configured to: receive the scrubbed data request transmitted by the scrubbing center, and perform data filtering on the scrubbed data request according to the protection information, to obtain a target data request after a data request of an abnormal behavior type is filtered out; and
the target data request transmission module 1604 is configured to transmit the target data request to the client server.

In some embodiments, the protection information includes a protection list. The second scrubbing module 1603 is further configured to: obtain a source address corresponding to the scrubbed data request; obtain, from the scrubbed data request, a fourth data request with the source address belonging to the protection list; and scrub the fourth data request to obtain the target data request.

In some embodiments, the protection information and network address transmission module 1602 is specifically configured to: transmit the protection information and the network address to the scrubbing center, to instruct the scrubbing center to obtain the corresponding target network segment based on the network address, broadcast the target network segment to the network operator, and receive a data request that is forwarded by the network operator and corresponds to the target network segment. The network operator and the cloud server are located in a same geographic area.

In some embodiments, the apparatus for protecting against the abnormal network behavior further includes: a second dial test module, configured to transmit a dial test request to the scrubbing center; and transmit a masking instruction to the scrubbing center in response to that a response made by the scrubbing center to the dial test request times out, to instruct the scrubbing center to stop broadcasting the target network segment to the network operator.

In some embodiments, the apparatus for protecting against the abnormal network behavior further includes: an association module.

The association module is configured to establish, in response to an association request transmitted by the client server, an association relationship between the network address of the client server and the cloud server, the network address being an address that is requested based on a protection service possessed by the client server and has a protection attribute.

In some embodiments, the apparatus for protecting against the abnormal network behavior further includes: a scrubbing information transmission module.

The scrubbing information transmission module is configured to: receive scrubbing information transmitted by the scrubbing center after the scrubbing center performs the data scrubbing on the data request; obtain an abnormal behavior type, a quantity of requests corresponding to the abnormal behavior type, and abnormal behavior time corresponding to the abnormal behavior type based on the scrubbing information in response to a protection overview instruction transmitted by the client server; and transmit the abnormal behavior type, the quantity of requests corresponding to the abnormal behavior type, and the abnormal behavior time corresponding to the abnormal behavior type to the client server, to instruct the client server to transmit the abnormal behavior type, the quantity of requests corresponding to the abnormal behavior type, and the abnormal behavior time corresponding to the abnormal behavior type to a client, for enabling the client to display a protection overview page according to the abnormal behavior type, the quantity of requests corresponding to the abnormal behavior type, and the abnormal behavior time corresponding to the abnormal behavior type to the client server.

All or some of the modules in the foregoing apparatus for protecting against the abnormal network behavior may be implemented by using software, hardware, or a combination thereof. The foregoing modules may be built in or independent of a processor of a computer device in a form of hardware, or may be stored in a memory of the computer device in a form of software, for the processor to invoke to execute operations corresponding to the foregoing modules.

In some embodiments, a computer device is provided. The computer device may be a scrubbing center or a cloud server, an internal structure of which may be shown in FIG. 17. The computer device includes a processor, a memory, an input/output (I/O) interface, and a communication interface. The processor, the memory, and the input/output interface are connected through a system bus, and the communication interface is connected to the system bus through the input/output interface. The processor of the computer device is configured to provide computing and control capabilities. The memory of the computer device includes a non-volatile storage medium and an internal memory. The non-volatile storage medium stores an operating system, computer programs, and databases. The inner memory provides an operating environment for the operating system and the computer programs in the non-volatile storage medium. The databases of the computer device are configured to store data requests, protection information, and network addresses. The input/output interface of the computer device is configured to exchange information between the processor and an external device. The communication interface of the computer device is configured to connect and communicate with an external terminal through a network. The computer program is run by the processor to implement a method for protecting against an abnormal network behavior.

A person skilled in the art can understand that the structure shown in FIG. 17 is merely a block diagram of a partial structure related to a solution in the present disclosure, and does not constitute a limitation on the computer device to which the solution in the present disclosure is applied. Specifically, the computer device may include more or fewer components than those shown in the figure, or some components may be combined, or a different component layout may be used.

In some embodiments, a computer device is provided, including: a memory and a processor. The memory has a computer program stored therein, and the processor, when running the computer program, implements the foregoing method for protecting against the abnormal network behavior.

In some embodiments, a computer-readable storage medium is provided, having a computer program stored therein, the computer program, when run by a processor, implementing the foregoing method for protecting against the abnormal network behavior.

In some embodiments, a computer program product is provided, including a computer program, the computer program, when run by a processor, implementing the foregoing method for protecting against the abnormal network behavior.

In addition, user information (including, but not limited to, user equipment information, user personal information, and the like) and data (including, but not limited to, data for analysis, stored data, displayed data, and the like) involved in the present disclosure are all information and data authorized by users or fully authorized by all parties, and collection, use, and processing of relevant data need to comply with relevant laws, regulations, and standards of relevant countries and regions.

A person of ordinary skill in the art may understand that all or some of procedures of the method in the foregoing embodiments may be implemented by a computer program instructing relevant hardware. The program may be stored in a non-volatile computer-readable storage medium. When the program is executed, the procedures of the foregoing method embodiments may be implemented. Any reference to the memory, the database, or other media used in the embodiments provided in the present disclosure can include at least one of a non-volatile memory and a volatile memory. The non-volatile memory can include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory can include a random access memory (RAM), external cache memory, or the like. As an illustration, not a limitation, the RAM may be in many forms, such as a static random access memory (SRAM) or a dynamic random access memory (DRAM). The databases involved in the various embodiments provided in the present disclosure may include at least one of a relational database and a non-relational database. The non-relational database may include a blockchain-based distributed database, or the like, but is not limited thereto. The processor involved in the embodiments provided in the present disclosure may be a general-purpose processor, a central processing unit, a graphics processing unit, a digital signal processor, a programmable logic device, a quantum computing-based data processing logic device, or the like, but is not limited thereto.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

The foregoing embodiments show only several implementations of the present disclosure and are described in detail, which, however, are not to be construed as a limitation to the patent scope of the present disclosure. It should be noted that for a person of ordinary skill in the art, several transformations and improvements can be made without departing from the idea of the present disclosure. These transformations and improvements belong to the protection scope of the present disclosure. Therefore, the protection scope of the present disclosure shall be subject to the appended claims.

What is claimed is:

1. A method for protecting against an abnormal network behavior, performed by a scrubbing center, and comprising:
receiving a data request corresponding to a target network segment forwarded by a network operator, the target network segment corresponding to a network address of a client server;
obtaining protection information corresponding to the network address, the protection information being generated by the client server based on a service requirement;
performing data scrubbing on the data request based on the protection information to obtain a scrubbed data request; and
transmitting the scrubbed data request to the cloud server to instruct the cloud server to perform data filtering on the scrubbed data request according to the protection information to obtain a target data request after a data request of an abnormal behavior type is filtered out, and transmitting the target data request to the client server.

2. The method according to claim 1, further comprising:
receiving the network address of the client server transmitted by the cloud server;
obtaining the target network segment corresponding to the network address; and
broadcasting the target network segment to the network operator, the network operator and the cloud server being located in a same geographic area.

3. The method according to claim 2, further comprising:
receiving a dial test request transmitted by the cloud server;
receiving, in response to that a response to the dial test request times out, a masking instruction transmitted by the cloud server; and
stopping broadcasting the target network segment to the network operator based on the masking instruction.

4. The method according to claim 1, wherein the obtaining protection information corresponding to the network address comprises:
receiving the protection information that is transmitted by the cloud server and corresponds to the network address.

5. The method according to claim 1, wherein the performing data scrubbing on the data request based on the protection information to obtain a scrubbed data request comprises:
obtaining quintuple information based on the data request;
determining, from the data request corresponding to the target network segment based on the quintuple information, a candidate data request corresponding to the network address; and
scrubbing the candidate data request based on the protection information, to obtain the scrubbed data request.

6. The method according to claim 5, wherein the protection information comprises a protection list; and the scrubbing the candidate data request based on the protection information, to obtain the scrubbed data request comprises:
obtaining a source address corresponding to the candidate data request;
obtaining, from the candidate data request, a first data request to be scrubbed with the source address belonging to the protection list; and
scrubbing the first data request to obtain the scrubbed data request.

7. The method according to claim 5, wherein the protection information comprises a blocked transmission protocol; and the scrubbing the candidate data request based on the protection information, to obtain the scrubbed data request comprises:
obtaining, from the candidate data request in response to that a traffic of the candidate data request is greater than a traffic threshold, a second data request to be scrubbed with a transmission protocol belonging to the blocked transmission protocol; and
scrubbing the second data request to obtain the scrubbed data request.

8. The method according to claim 5, wherein the protection information comprises a protection list and a blocked transmission protocol; and the scrubbing the candidate data request based on the protection information, to obtain the scrubbed data request comprises:
obtaining a source address corresponding to the candidate data request;
obtaining, from the candidate data request, a first data request to be scrubbed with the source address belonging to the protection list;
obtaining, from the candidate data request in response to that a traffic of the candidate data request is greater than a traffic threshold, a second data request to be scrubbed with a transmission protocol belonging to the blocked transmission protocol; and
scrubbing the first data request and the second data request to obtain the scrubbed data request.

9. The method according to claim 5, wherein the protection information comprises a non-protection list and a blocked transmission protocol; and the scrubbing the candidate data request based on the protection information, to obtain the scrubbed data request comprises:
obtaining, from the candidate data request in response to that a traffic of the candidate data request is greater than a traffic threshold, a second data request to be scrubbed with a transmission protocol belonging to the blocked transmission protocol;
determining, from the second data request, a third data request to be scrubbed with the source address not belonging to the non-protection list; and
scrubbing the third data request to obtain the scrubbed data request.

10. A method for protecting against an abnormal network behavior, performed by a cloud server, and comprising:
receiving protection information that is determined by a client server based on a service requirement and corresponds to a network address, the network address being an address of a network of the client server;
transmitting the protection information and the network address to a scrubbing center, to instruct the scrubbing center to receive a data request that is forwarded by a network operator and corresponds to a target network segment, and to perform data scrubbing on the data request based on the protection information, to obtain a scrubbed data request, the target network segment being a network segment corresponding to the network address;
receiving the scrubbed data request transmitted by the scrubbing center, and performing data filtering on the scrubbed data request according to the protection information, to obtain a target data request after a data request of an abnormal behavior type is filtered out; and
transmitting the target data request to the client server.

11. The method according to claim 10, wherein the protection information comprises a protection list; and the performing data filtering on the scrubbed data request according to the protection information, to obtain a target data request after a data request of an abnormal behavior type is filtered out comprises:
obtaining a source address corresponding to the scrubbed data request;
obtaining, from the scrubbed data request, a fourth data request to be scrubbed with the source address belonging to the protection list; and
scrubbing the fourth data request to obtain the target data request.

12. The method according to claim 10, wherein the transmitting the protection information and the network address to a scrubbing center, to instruct the scrubbing center to receive a data request that is forwarded by a network operator and corresponds to a target network segment comprises:
transmitting the protection information and the network address to the scrubbing center, to instruct the scrubbing center to obtain the target network segment corresponding to the network address, broadcasting the target network segment to the network operator, and receiving the data request that is forwarded by the network operator and corresponds to the target network segment, the network operator and the cloud server being located in a same geographic area.

13. The method according to claim 12, further comprising:
transmitting a dial test request to the scrubbing center; and
transmitting a masking instruction to the scrubbing center in response to that a response made by the scrubbing center to the dial test request times out, to instruct the scrubbing center to stop broadcasting the target network segment to the network operator.

14. The method according to claim 10, further comprising:
establishing, in response to an association request transmitted by the client server, an association relationship between the network address of the client server and the cloud server, the network address being an address that is requested based on a protection service possessed by the client server and has a protection attribute.

15. The method according to claim 10, further comprising:
receiving scrubbing information transmitted by the scrubbing center after the scrubbing center performs the data scrubbing on the data request;
obtaining an abnormal behavior type, a quantity of requests corresponding to the abnormal behavior type, and abnormal behavior time corresponding to the abnormal behavior type based on the scrubbing information in response to a protection overview instruction transmitted by the client server; and
transmitting the abnormal behavior type, the quantity of requests corresponding to the abnormal behavior type, and the abnormal behavior time corresponding to the abnormal behavior type to the client server, to instruct the client server to transmit the abnormal behavior type, the quantity of requests corresponding to the abnormal behavior type, and the abnormal behavior time corresponding to the abnormal behavior type to a client, for enabling the client to display a protection overview page according to the abnormal behavior type, the quantity of requests corresponding to the abnormal behavior type, and the abnormal behavior time corresponding to the abnormal behavior type to the client server.

16. One or more non-transitory readable storage media, having computer-readable instructions stored therein, the computer-readable instructions, when executed by one or more processors, causing the one or more processors to execute:
receiving a data request corresponding to a target network segment forwarded by a network operator, the target network segment corresponding to a network address of a client server;
obtaining protection information corresponding to the network address, the protection information being generated by the client server based on a service requirement;
performing data scrubbing on the data request based on the protection information to obtain a scrubbed data request; and
transmitting the scrubbed data request to the cloud server to instruct the cloud server to perform data filtering on the scrubbed data request according to the protection information to obtain a target data request after a data request of an abnormal behavior type is filtered out, and transmitting the target data request to the client server.

17. The storage media according to claim 16, wherein the computer-readable instructions further cause the one or more processors to execute:
receiving the network address of the client server transmitted by the cloud server;
obtaining the target network segment corresponding to the network address; and
broadcasting the target network segment to the network operator, the network operator and the cloud server being located in a same geographic area.

18. The storage media according to claim 17, wherein the computer-readable instructions further cause the one or more processors to execute:
receiving a dial test request transmitted by the cloud server;
receiving, in response to that a response to the dial test request times out, a masking instruction transmitted by the cloud server; and
stopping broadcasting the target network segment to the network operator based on the masking instruction.

19. The storage media according to claim 16, wherein the obtaining protection information corresponding to the network address comprises:
receiving the protection information that is transmitted by the cloud server and corresponds to the network address.

20. The storage media according to claim 16, wherein the performing data scrubbing on the data request based on the protection information to obtain a scrubbed data request comprises:
obtaining quintuple information based on the data request;
determining, from the data request corresponding to the target network segment based on the quintuple information, a candidate data request corresponding to the network address; and
scrubbing the candidate data request based on the protection information, to obtain the scrubbed data request.
